(19) United States
(12) Patent Application Publication
(10) Pub. No.: US 2008/0179234 A1
(43) Pub. Date: Jul. 31, 2008

(54) Adjustable Height Filter Cartridge

(75) Inventor: James E Roberts, Whitmore Lake, MI (US)

Correspondence Address: BABCOCK IP, PLLC, P.O.BOX 488, BRIDGMAN, MI, 49106, US

(73) Assignee: Dale P. Fosdick, Saline, MI (US)

(21) Appl. No.: 11/627,319

(22) Filed: Jan. 25, 2007

(51) Int. Cl. B01D 35/30

(52) U.S. Cl. 210/232

(57) ABSTRACT

A filter cartridge has a cartridge top and a cartridge bottom interconnected by a cartridge sidewall. The cartridge top, the cartridge bottom and the cartridge sidewall enclose a filter media. An extension connectable to the cartridge bottom via threads is adjustable to fit the filter cartridge within a range of differently sized housings.

### BACKGROUND

1. Field of the Invention

The present invention generally relates to filter media. More specifically, the present invention relates to a filter cartridge usable within a range of different filter housings requiring varying filter cartridge height mounting configurations.

2. Description of Related Art

Filter media is used in a wide range of processes such as the removal of solid contaminants from liquid process flows. A filter housing is dimensioned to receive filter media. Process connections to the filter housing direct a process flow through the filter media, whereby the filter media operates to filter the process flow to a pore size of the filter media. Because the filter media eventually becomes fouled by the trapped filtrand, the filter housings are adapted to allow easy exchange of the filter media.

A typical filter housing has a filter basket or cage adapted to receive and or support the filter media. Although filter baskets are supplied with standardized diameters to allow a range of different filter media to reliably seal against the filter basket sidewall and or top surface(s), filter baskets of varied design and or manufacturers have significantly different depths between the top edge and the bottom. The filter basket may have different sidewall lengths and or different types of bottoms, such as a flat, conical or domed.

Filter cartridges support filter media within a top, bottom and sidewall. Ongoing efforts to make filter cartridges cost efficient have led to minimization of structural material applied to the sidewalls, top and bottom.

The routing of the process media into the filter cartridge at the top and out through the sidewalls and or bottom focuses hydraulic shocks occurring in the filter housing during process starts, stops and interruptions upon the bottom and or connection between the bottom and sidewalls. One way to prevent damage to the filter cartridge from hydraulic shock is to seat the filter cartridge against the filter basket bottom, whereby any hydraulic shock is transferred through the filter cartridge bottom to the filter basket bottom. Because of the varied range of heights between the filter basket top and the filter basket bottom of the various filter housings available, prior filter cartridges have been filter housing/filter basket specific, increasing the number of different models of filter cartridges a manufacturer has been required to manufacture and maintain an inventory of. Also, a user with different models of filter housings would have to ensure the proper filter cartridge is inserted into the corresponding filter housing and maintain an increased stock of multiple models of filter cartridges. Alternatively, filter cartridges have been designed for use without bottom support, which significantly increases manufacturing costs due to the increased top, bottom and sidewall supporting material required to make the filter cartridge strong enough to be resistant to failure from hydraulic shock, absent the support of the filter basket bottom.

Competition within the filter cartridge industry has focused attention upon reliability, reduction of inventory requirements and reductions in manufacturing costs.

Therefore, it is an object of the present invention to provide a method and apparatus that overcomes deficiencies in the prior art.

### BRIEF DESCRIPTION OF THE FIGURES

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a side cross sectional isometric view of a first exemplary embodiment of a filter cartridge according to the invention.

FIG. 2 is a side cross sectional isometric view of a second exemplary embodiment of a filter cartridge according to the invention.

FIG. 3 is a close-up side cross sectional isometric view of the bottom section of a third exemplary embodiment of a filter cartridge according to the invention.

FIG. 4 is a side cross sectional isometric view of a filter housing with the filter cartridge of FIG. 1 installed.

### DETAILED DESCRIPTION

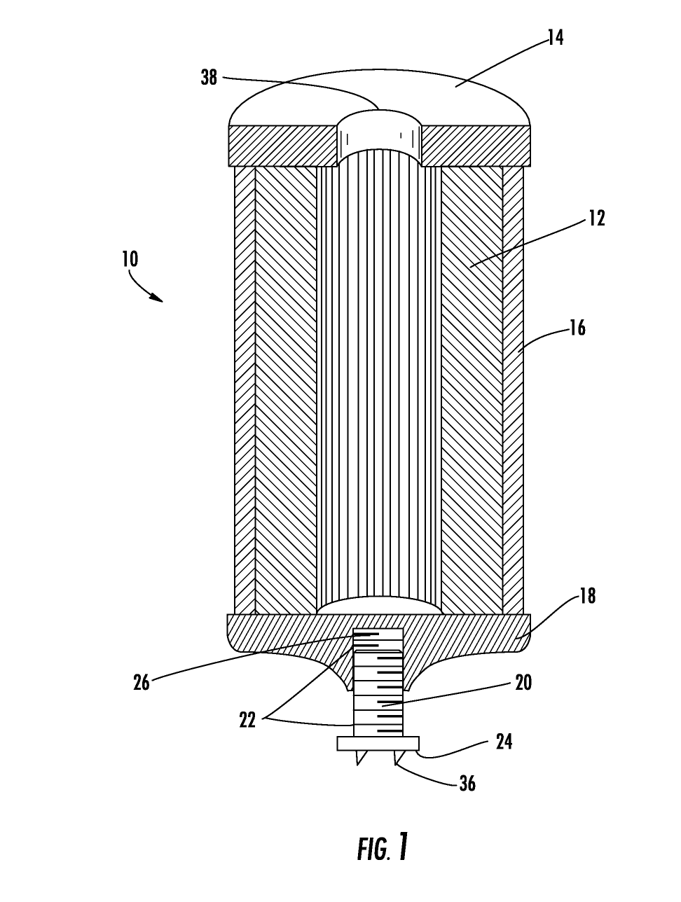

A filter cartridge 10, for example as shown in FIG. 1, supports the filter media 12 between an external support structure comprised of a cartridge top 14, a cartridge sidewall 16 and a cartridge bottom 18. To ensure that the process flow passes only through the filter media, the filter media 12 may be sealed against and or fused to the cartridge top 14 and the cartridge bottom 18. One skilled in the art will appreciate that the filter media 12 and mounting configuration within the filter cartridge 10 may be selected from a wide range of materials for a desired chemical resistance/reaction, strength, porosity, surface area and or cost.

The filter cartridge 10 has an adjustable height feature in the form of an extension 20 connected to the cartridge bottom 18 via threads 22. By threading the extension 20 towards the cartridge bottom 18 and or away from the cartridge bottom 18, a desired height of the filter cartridge 10 between a top of the cartridge top 14 and the extension bottom 24 is achieved.

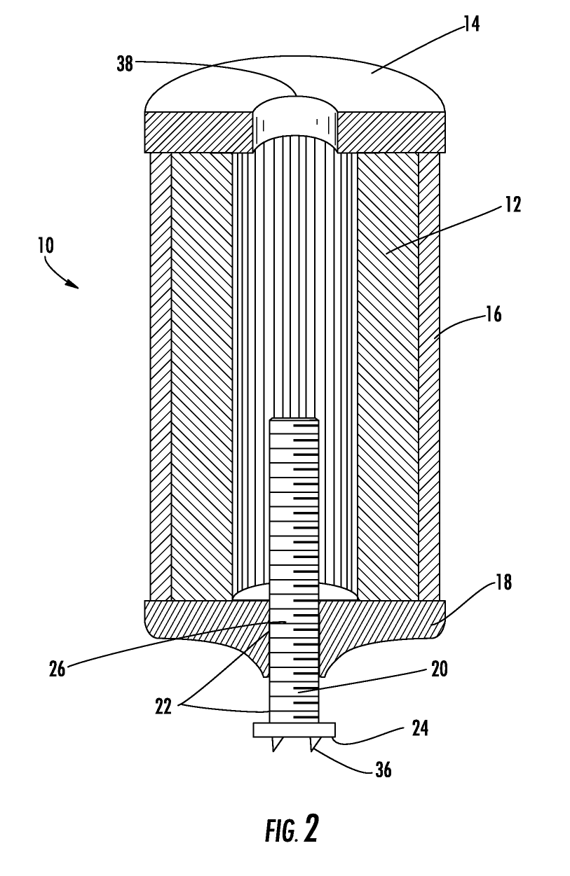

The extension 20 may be formed, for example, as a threaded screw, screwing into threads 22 of a threaded hole 26 formed in the cartridge bottom. To allow threading about a longitudinal axis of the filter cartridge 10, the threaded hole 26 may be formed coaxial with the cartridge sidewall 16. For failsafe operation of the filter cartridge 10, the threaded hole 26 may be formed with a depth less than that of the cartridge bottom 18. Thereby, the process flow can never pass through the threaded hole 26, without first passing through the filter media 12. Alternatively, as shown for example in FIG. 2, for maximum range of height adjustment, the threaded hole 26 may extend through the cartridge bottom to enable use of an extension 20 with an extended length, the threaded end of the extension 20 extending up into the filter cartridge 10 process flow area when a minimum height is desired.

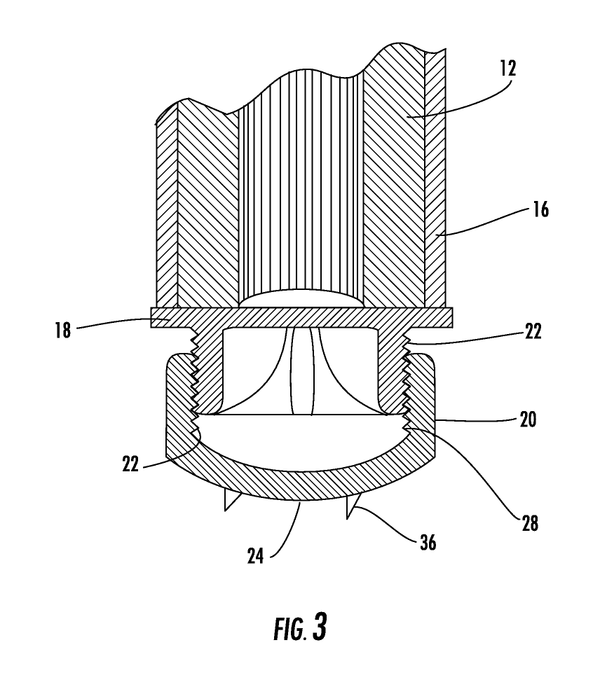

Alternatively, the extension 20 may be formed, for example as shown in FIG. 3, to thread upon threads 22 formed around an outer edge of the cartridge bottom 18 that mate with inward projecting threads 22 formed on an inner diameter upper shoulder of the extension 20.

The extension 20 may be formed from a cost effective material compatible with the process flow, such as a polymer, metal or ceramic. For maximum cost efficiency, the extension 20 may be formed from a durable material, such as stainless steel or the like, that may be repeatedly re-used by removal and re-installation as each used filter cartridge 10 is periodically exchanged for a new filter cartridge 10.

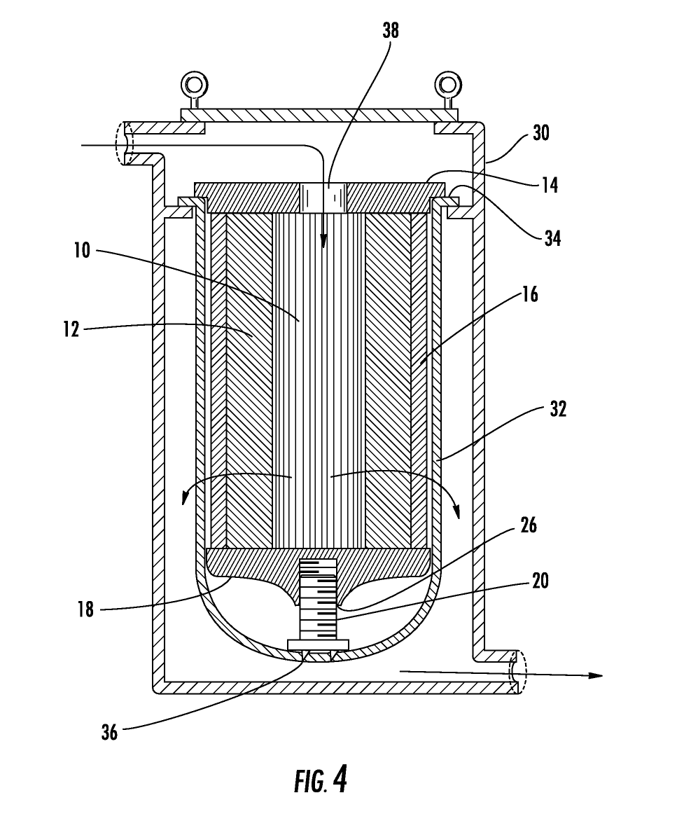

Used with a filter housing, for example as shown in FIG. 4, the filter cartridge 10 is inserted into the filter basket 32 until the extension bottom 24 bottoms against the filter basket 32. Threading the extension 20 towards or away from the cartridge bottom 18 adjusts the height to a desired level, for example so that the cartridge top 14 seals against a desired portion of the filter basket top 34. Sealing between the cartridge top 14 periphery and the filter basket 32 is demonstrated as an overhanging lip feature.

However, one skilled in the art will appreciate that any number of different lip seals, flanges, biased edges, o-rings or other gaskets may be applied to provide a satisfactory seal. With the filter cartridge 10 properly seated into the filter basket 32, a process flowpath is enabled. The process flowpath enters the filter housing 30, passes through a process hole 38 in the filter cartridge top 14, then through the filter media 12, cartridge sidewall 16 and filter basket 32 before exiting the filter housing 30.

To ensure that the selected extension level does not change during process operation from vibration or the like, the extension bottom 24 may be formed with one or more protrusions 36 that key into perforations 36 of the filter basket 32. The protrusion(s) 36 may be formed, for example, as a conical or pyramidal shape.

The protrusion(s) 36 also enable an installation operation wherein the filter cartridge 10 is inserted into the filter basket 32 until it bottoms, and then the height is adjusted to a desired level, by threading the cartridge top 14 and thereby the entire supporting structure, for example to where the cartridge top 14 periphery seals against a corresponding section of the filter basket top 34, the extension bottom 24 protrusion(s) keyed with the filter basket.

One skilled in the art will appreciate that a filter cartridge according to the appended claims enables design and manufacture of filter cartridges for use in a range of different filter housings and or filter baskets. The adjustable height nature of the invention ensures that the bottom and or sidewall/bottom interconnection is supported by the filter basket bottom, reducing the strength requirements of the external support structure and in particular improving resistance against damage from hydraulic shock. Because the invention eliminates the need for manufacture, inventory and delivery of a significant number of different filter cartridge models, manufacturing and operating costs are significantly reduced.

Table of Parts

| | |
|---|---|
| 10 | filter cartridge |
| 12 | filter media |
| 14 | top |
| 16 | sidewall |
| 18 | bottom |
| 20 | extension |
| 22 | threads |
| 24 | extension bottom |
| 26 | hole |
| 28 | shoulder |
| 30 | filter housing |
| 32 | filter basket |
| 34 | filter basket top |
| 36 | protrusion |
| 38 | process hole |

Where in the foregoing description reference has been made to ratios, integers, materials, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A filter cartridge comprising:
a cartridge top and a cartridge bottom interconnected by a cartridge sidewall;
the cartridge top, the cartridge bottom and the cartridge sidewall enclosing a filter media; and
an extension connectable to the cartridge bottom via threads;
the extension operable via threading to vary an overall height of the filter cartridge.

2. The filter cartridge of claim 1, wherein an extension bottom of the extension has at least one protrusion.

3. The filter cartridge of claim 2, wherein the at least one protrusion is a pyramid shape.

4. The filter cartridge of claim 1, wherein the bottom has a threaded hole for receiving the extension; the threaded hole having a depth less than a thickness of the cartridge bottom.

5. The filter cartridge of claim 4, wherein the threaded hole is coaxial with the cartridge sidewall.

6. The filter cartridge of claim 1, wherein the cartridge bottom is provided with outward projecting threads on an outer diameter; and
the extension is provided with mating threads projecting inward from an upper shoulder.

7. A filter cartridge for filtering a process media, comprising:
a cartridge top and a cartridge bottom interconnected by a cartridge sidewall;
the cartridge top, the cartridge bottom and the cartridge sidewall cooperating to support a filter media;
the filter media sealed against the cartridge top and the cartridge bottom;
the cartridge top having a process hole and the cartridge sidewall having a sidewall aperture whereby the process media may pass into the filter cartridge through the process hole through the filter media and out the sidewall aperture; and
an extension connectable to the cartridge bottom via threads, a net height dimension of the filter cartridge selectable via threading of the extension into the cartridge bottom.

8. The filter cartridge of claim 7, wherein an extension bottom of the extension has at least one protrusion

9. The filter cartridge of claim 8, wherein the at least one protrusion is a pyramid shape.

10. The filter cartridge of claim 7, wherein the bottom has a threaded hole for receiving the extension; the threaded hole having a depth less than a thickness of the cartridge bottom.

11. The filter cartridge of claim 7, wherein the cartridge bottom is provided with outward projecting threads on an outer diameter; and
the extension is provided with mating threads projecting inward from an upper shoulder.

12. A filter cartridge for filtering a process media passing through a filter housing with a filter basket, comprising:
an exterior support structure having a cartridge top and a cartridge bottom interconnected by a cartridge sidewall;
the exterior support structure cooperating to enclose a filter media;
the filter media sealed against the cartridge top and the cartridge bottom;
the exterior support structure dimensioned for insertion into the filter basket; the cartridge top sealing against a top of the filter basket;
the cartridge top provided with a process hole and the cartridge sidewall provided with a sidewall aperture whereby the process media may pass into the filter cartridge through the process hole through the filter media and out the sidewall aperture; and
an extension connectable to the cartridge bottom via threads, a net height dimension of the filter cartridge selectable via threading of the extension into the cartridge bottom, whereby the extension contacts a bottom of the filter basket when the cartridge top seals against the top of the filter basket.

13. The filter cartridge of claim 12, wherein an extension bottom of the extension has at least one protrusion

14. The filter cartridge of claim 13, wherein the at least one protrusion is a pyramid shape.

15. The filter cartridge of claim 12, wherein the at least one protrusion is dimensioned to pass through a perforation of the bottom of the filter basket, rotationally interlocking the extension with the filter basket.

16. The filter cartridge of claim 12, wherein the cartridge bottom is provided with a threaded hole for receiving the extension;

17. The filter cartridge of claim 16, wherein the threaded hole has a depth less than a thickness of the cartridge bottom.

18. The filter cartridge of claim 16, wherein the threaded hole is coaxial with the cartridge sidewall.

19. The filter cartridge of claim 12, wherein the cartridge bottom is provided with outward projecting threads on an outer diameter; and
the extension is provided with mating threads projecting inward from an upper shoulder.
